(19) United States
(12) Patent Application Publication
(10) Pub. No.: US 2021/0378416 A1
(43) Pub. Date: Dec. 9, 2021

(54) FOLDABLE MAT

(71) Applicant: Barbara S. Houghteling, Loveland, CO (US)

(72) Inventor: Barbara S. Houghteling, Loveland, CO (US)

(21) Appl. No.: 17/204,052

(22) Filed: Mar. 17, 2021

Related U.S. Application Data
(60) Provisional application No. 63/035,223, filed on Jun. 5, 2020.

(51) Int. Cl. A47D 5/00; A47D 15/00; B32B 7/09

(52) U.S. Cl. CPC A47D 5/006; A47D 15/003; B32B 2571/00; B32B 2307/7265; B32B 7/09

(57) ABSTRACT

A foldable mat, especially a mat useful for changing baby diapers.

### REFERENCE TO RELATED APPLICATIONS

The present application claims the benefit of priority to the inventor's U.S. Provisional Patent Application No. 63/035,223, filed Jun. 5, 2020, having the title “Foldable Mat”. The entire subject matter of that provisional patent application is incorporated herein by reference.

### FIELD OF THE INVENTION

The present invention relates to a foldable mat, especially a mat useful for changing baby diapers. The invention also relates to a method of making a foldable mat, a method of using a foldable mat, and the design of a foldable mat in various stages of being folded or unfolded.

### BACKGROUND OF THE INVENTION

Mats or pads are used for interposition between an animal or other object and a supporting surface. For example, a mat may be used for changing a baby's diapers, for picnics, for yoga exercises, for babies and toddlers at play, and for a variety of other purposes. An upper mat surface may be soiled through use. Also the lower surface in contact with a supporting surface such as a floor, a changing table, a picnic table, a shopping cart, a veterinary examination table, or the ground likewise may pick up debris or otherwise become soiled.

Often a way to thoroughly clean the mat immediately after use is not readily available in the vicinity where the mat is used, and the mat must be transported to a cleaning location such as a home sink or washing machine. The transport of a soiled mat can spread the soiling to a diaper bag, a tote bag, and other receptacles, to car seats, to strollers, to countertops, and of course to one's hands, for example. Further, with enhanced concern for the transmission of viruses and other harmful microbes, eliminating or containing soiling on mats is of heightened importance.

### SUMMARY OF THE INVENTION

The present invention relates to a mat that preferably may be folded upon itself. The mat preferably is principally fashioned of one or more sheets of plastic, canvas, woven cotton, or other materials, many of which are preferably waterproof, and are preferably fashioned of one or more materials that may be wiped clean easily with a sponge, cloth, or alcohol wipe. The mat preferably is completely washable in an automatic clothes washer.

The mat may be utilized for interposition between an animal or other object and a supporting surface. In a very preferred embodiment, the mat is useful as a pad for changing a baby's diapers by laying a baby on an upper mat surface. In addition, the invention contemplates that the mat may be employed, for example, as a play mat for babies and toddlers, as a dining table place mat, as a shopping cart mat, as a picnic mat to be placed either on the ground or on a picnic table, as a yoga mat, and for veterinary examinations. In the employment of the mat in various other embodiments, the dimensions and other characteristics of the mat may be modified.

The mat is preferably foldable such that, when unfolded, an upper surface of the mat faces the animal or other object and then, when re-folded, the upper surface faces upon itself and is not exposed as an exterior surface. Such a characteristic keeps any debris on the upper surface retained within the folded mat and from being exposed on an outside surface when re-folded, and permits the mat to be unfolded at home or another location where cleaning may be facilitated to wash the unfolded upper surface.

If for example, one has unfolded the mat, placed a baby on the unfolded mat, changed the baby's diaper, placed an ointment or powder on the baby which spills onto the mat, taken the baby away from the mat, and re-folded the mat, the spilled ointment and powder will be retained against the surface on which the baby was placed and will not migrate to other surfaces of the mat. Although one may of course wipe and otherwise clean the surface before re-folding, if it is inconvenient to clean the surface thoroughly while in the process of changing the baby, one may simply carry the folded mat home or to another more convenient location for unfolding and cleaning. Transport of the re-folded mat exposes only those areas of the mat that do not bear the ointment and powder, which allows the re-folded mat to be handled without contacting the ointment or powder.

When the mat is used for purposes such as yoga, the upward facing surface of the unfolded mat might receive sweat, hair, and dust, which would be retained in the interior of the mat when re-folding the mat. Likewise, if the mat is used for a picnic, the upward facing surface might receive spills and splatters of catsup, mustard, mayonnaise, pickle juice, meat juices, bread crumbs, etc., which similarly would be retained in the interior of the mat upon re-folding the mat for later cleaning.

When the mat is refolded, the surface of the mat that rested upon a supporting surface when unfolded will also be folded on itself and located within the interior, and not the exterior, of the folded mat. As such, contaminants from a supporting surface such as a public baby changing station, a picnic table, or the ground will be retained within the re-folded mat, and will not be exposed to one's hands, a diaper bag, a stroller, or a vehicle interior.

While the foregoing summary highlights some preferred features and advantages of the instant invention, the summary should nor be construed as limiting the nature of the invention.

### BRIEF DESCRIPTION OF THE DRAWINGS

The invention will be described with reference to the accompanying drawings, wherein:

FIG. 1 is a perspective view of a mat in accordance with one embodiment of the invention depicting the mat in a first stage of unfolding;

FIG. 2 is a perspective view of the mat shown in FIG. 1 depicting the mat in a second stage of unfolding;

FIG. 3 is a perspective view of the mat shown in FIG. 1 depicting the mat in a third stage of unfolding;

FIG. 4 is a perspective view of the mat shown in FIG. 1 depicting the mat in a fourth stage of unfolding;

FIG. 5 is a perspective view of the mat shown in FIG. 1 depicting the mat in a completely unfolded stage and resting on a supporting surface (not shown) for use;

FIG. 6 is a perspective view of the mat shown in FIG. 1 depicting the mat in a first stage of being re-folded;

FIG. 7 is a perspective view of the mat shown in FIG. 1 depicting the mat in a second stage of being refolded;

FIG. 8 is a perspective view of the mat shown in FIG. 1 depicting the mat in a third stage of being re-folded;

FIG. 9 is a perspective view of the mat shown n FIG. 1 depicting the mat in a third stage of being re-folded;

FIG. 10 is a perspective view of the mat shown in FIG. 1 depicting the mat in a fourth stage of being re-folded;

FIG. 11 is a perspective view of the mat shown in FIG. 1 depicting the mat in a folded stage;

FIG. 12 is another perspective view of the mat shown in FIG. 11;

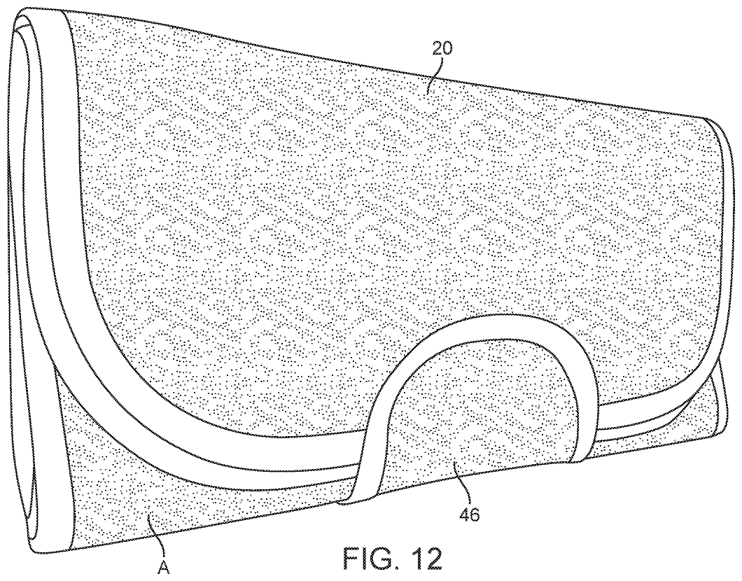

FIG. 13 is a top view of the mat shown in FIG. 11;

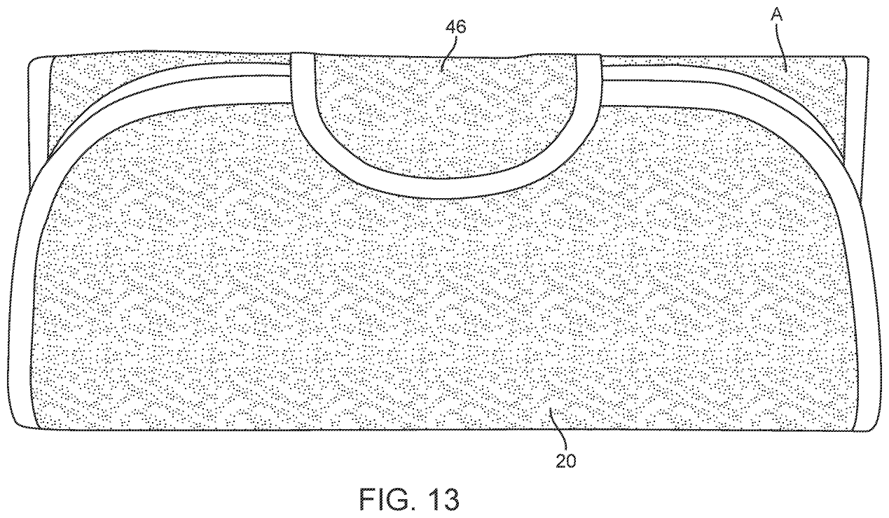

FIG. 14 is a bottom view of the mat shown in FIG. 11;

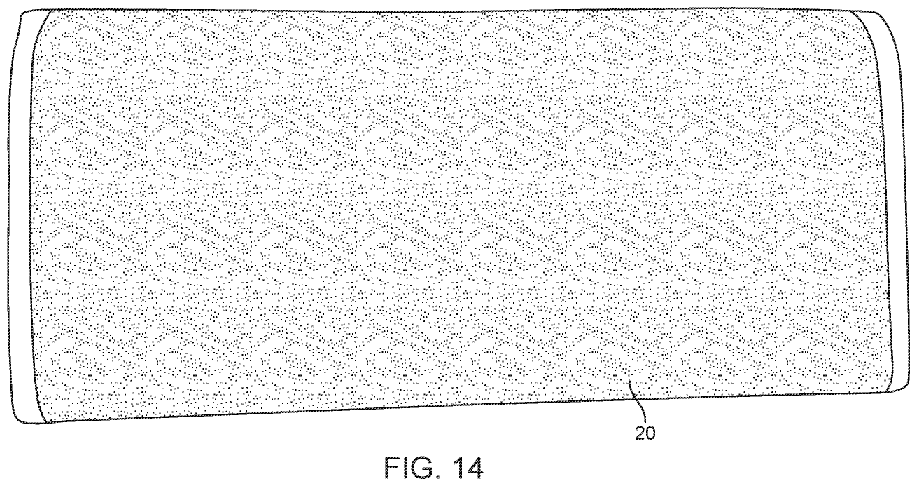

FIG. 15 is an end view of the mat shown in FIG. 11 taken at one end of the mat;

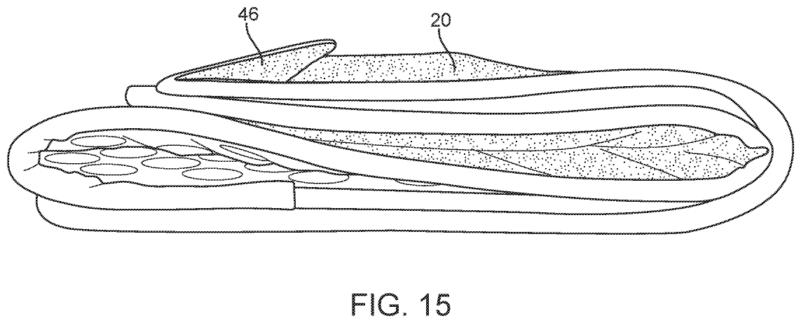

FIG. 16 is an end view of the mat shown in FIG. 11 taken at opposing end of the mat;

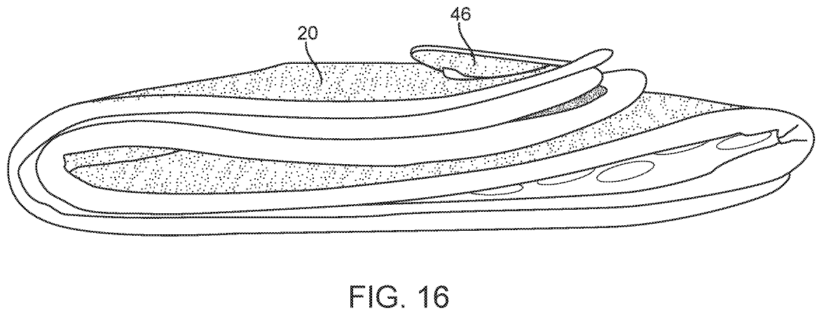

FIG. 17 is a side view of the mat shown in FIG. 11 taken at one side of the mat;

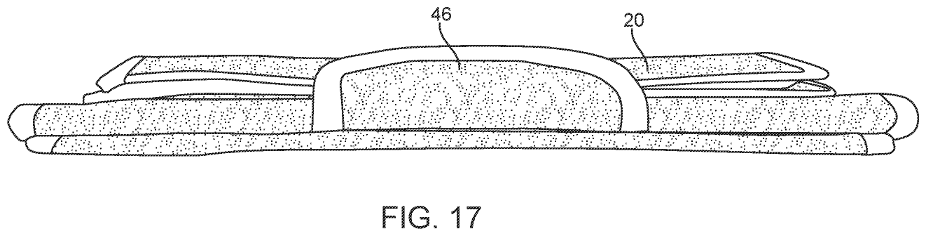

FIG. 18 is a side view of the mat shown in FIG. 11 taken at an opposing side of the mat.

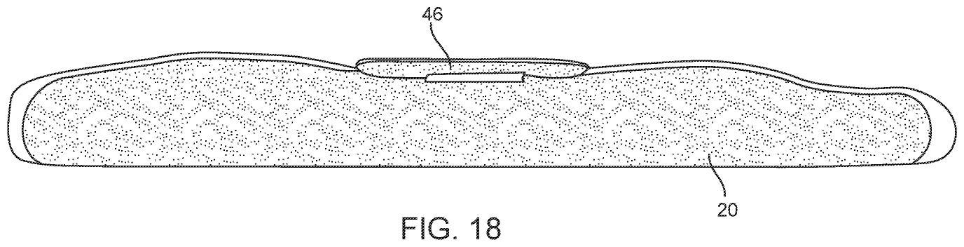

### DESCRIPTION OF A PREFERRED EMBODIMENT

A foldable mat in accordance with a preferred embodiment of the present invention is shown throughout the accompanying figures. The mat comprises a base layer 10 and an extending layer 12.

The base layer 10 preferably includes a first surface 14 and an opposing second surface 16. The base layer 10 and each of the surfaces 14, 16 thereof are generally rectangular in shape, preferably with rounded corners. Generally the base layer 10 and each of the surfaces 14, 16 thereof form a rectangle having opposing longitudinal ends and opposing lateral sides. The surfaces 14 and 16 are preferably secured together with an edge trim 18 by which the peripheral edges of the surfaces 14, 16 are sewn together. Alternatively the peripheral edges may be adhered or otherwise secured together. Also, in an alternative embodiment, a sheet of foam or other material may be inserted and interposed between the surfaces 14, 16 and sewn, adhered, or otherwise secured to the surfaces 14, 16.

The first surface 14 of the base layer 10 is shown decorated with polka dots in the accompanying figures and is preferably fashioned as a single sheet of unitary material, preferably a water resistant or waterproof material. Further, since the first surface 14 is adapted to receive a baby or other object thereon, the material forming the first surface is preferably relatively smooth and easy to clean with a damp cloth or sponge or an alcohol wipe.

The extending layer 12 preferably includes a first surface 20 and an opposing second surface 22. The extending layer 12 and each of the surfaces 20, 22 thereof are generally rectangular in shape, preferably with rounded corners at one longitudinal end thereof. Generally the extending layer 12 and the surfaces 20, 22 thereof form a rectangle having opposing longitudinal ends and opposing lateral sides. The surfaces 20, 22 are preferably secured together with an edge trim 24 by which three of the peripheral edges of the surfaces 20, 22 are sewn together. Alternatively the peripheral edges may be adhered or otherwise secured together. Also, in an alternative embodiment, a sheet of foam or other material may be inserted and interposed between the surfaces 20, 22 and sewn, adhered, or otherwise secured to the surfaces 20, 22.

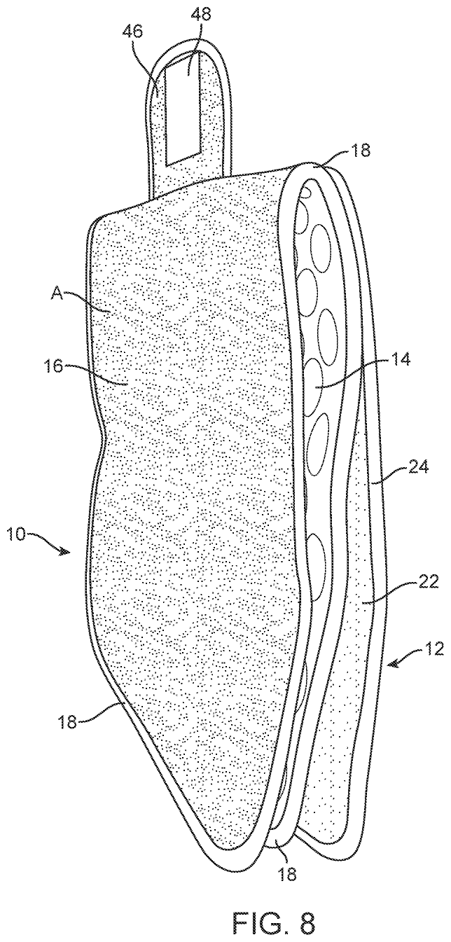

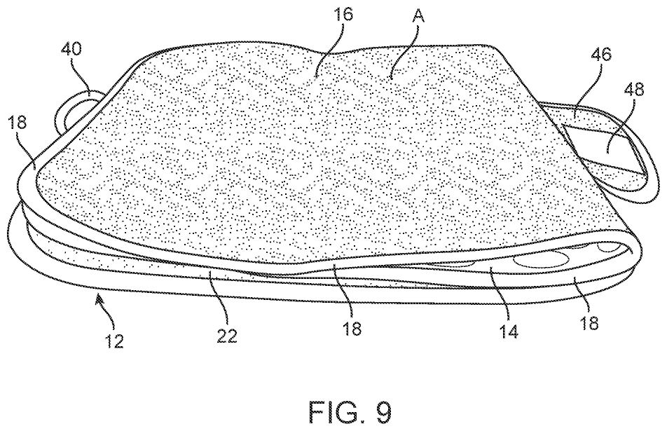

The longitudinal end of the extending layer 12 not formed with rounded corners is secured to the base layer 10. Preferably that longitudinal end is sewn to the base layer 10 preferably along a line forming the midway between the two opposing longitudinal ends of the base layer 10. Alternatively that longitudinal end may be selectively secured to the base layer 10 by a cooperative hook and loop fastener member, by a cooperative male and female snap fit connector, or by a zipper. It will be appreciated that the joinder of the longitudinal end of the extending layer 12 essentially bisects the second surface of the base layer 10 into two equally sized portions, an A portion and a B portion. Also preferably, the width of the extending layer 12 is the same as the width of the base layer 10, and the length of the extending layer 12 is one-half of the length of the base layer 10. It will be appreciated that, as so constructed, the extending layer 12 may flip between two positions adjacent to and intimately facing the second surface 16 of the base layer 10 and that when so flipped, the extending layer 12 will overlap either the A portion or the B portion with essentially overlapping, coextensive peripheral edges, as best shown in FIGS. 8 and 9.

Preferably the materials forming the base layer 10 and the extending layer 12 are flexible and deformable and machine washable. Also preferably the materials are color coded, are imprinted with different patterns, have different textures, or otherwise possess differentiating characteristics to assist the user in unfolding and folding the mat. For example, the first surface 14 of the base layer 10 is shown as having a polka dot pattern. The first surface 20 of the extending layer 12 and the A portion of the second surface 16 of the base layer 10 may also be formed of the same material and/or the same color of material. The second surface 22 of the extending layer 12 and the B portion of the second surface 16 of the base layer 10 may also be formed of the same material and/or the same color of material. As will later be appreciated, these latter surfaces will be adapted to be placed against an underlying support surface, such as a changing table, a picnic table, a floor, or the ground. As such, the material funning these latter surfaces should be relatively smooth and easy to wipe clean with a damp cloth or sponge or an alcohol wipe.

A loop 40 may be affixed such as by sewing centrally to one longitudinal end of the base layer 10, and a tab 42 may be affixed such as by sewing centrally to the opposing longitudinal end of the base layer 10. A closure flap 46 may be affixed such as by sewing centrally where the extending layer 12 joins the base layer 10. In a preferred embodiment the closure flap 46 bears a first portion 48 of a cooperative hook and loop fastener member, and the second portion 50 of the hook and loop fastener member is secured to the surface 20 of the extending layer 12 centrally along the longitudinal end thereof opposite to the longitudinal end where the extending layer 12 is secured to the base layer 10.

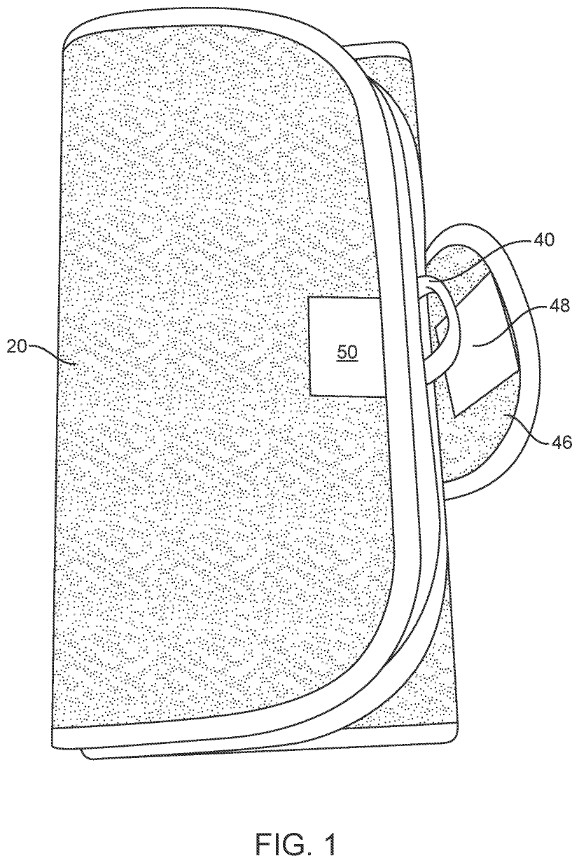

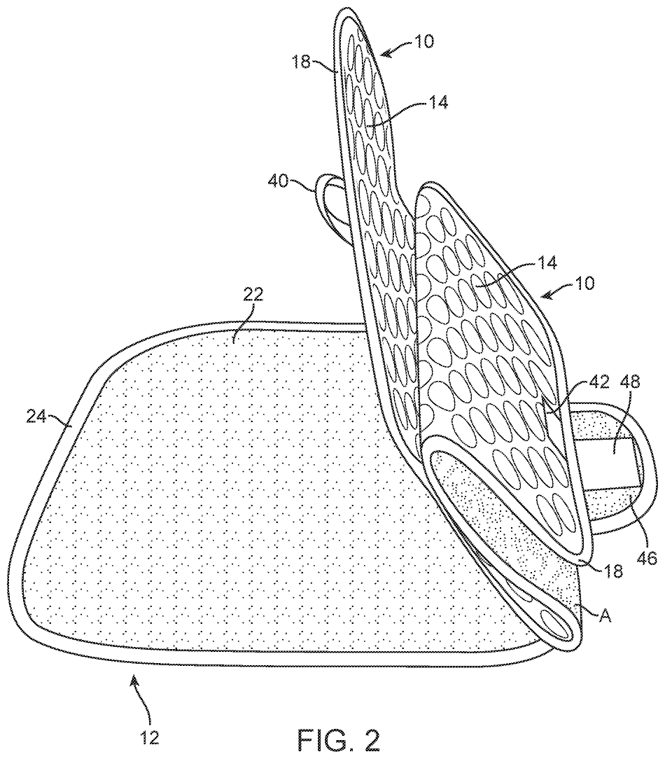

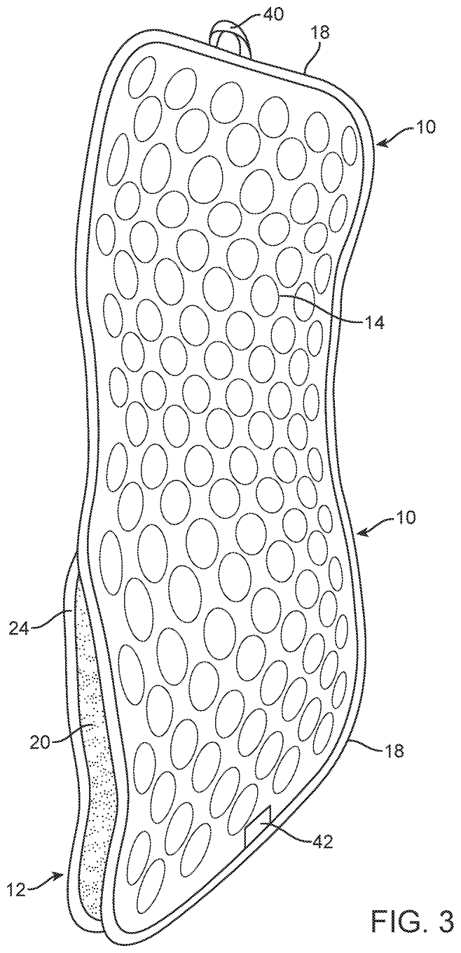

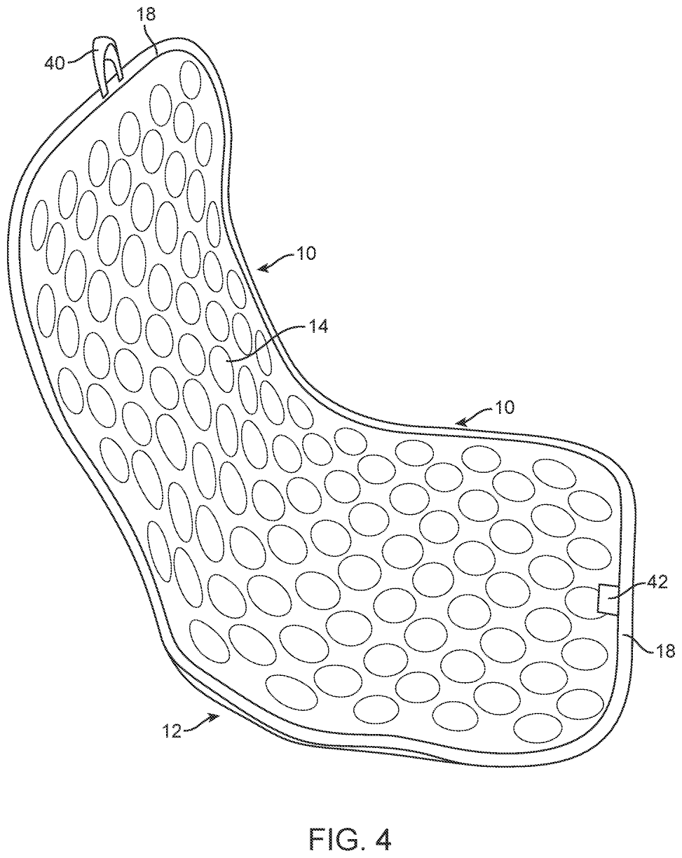

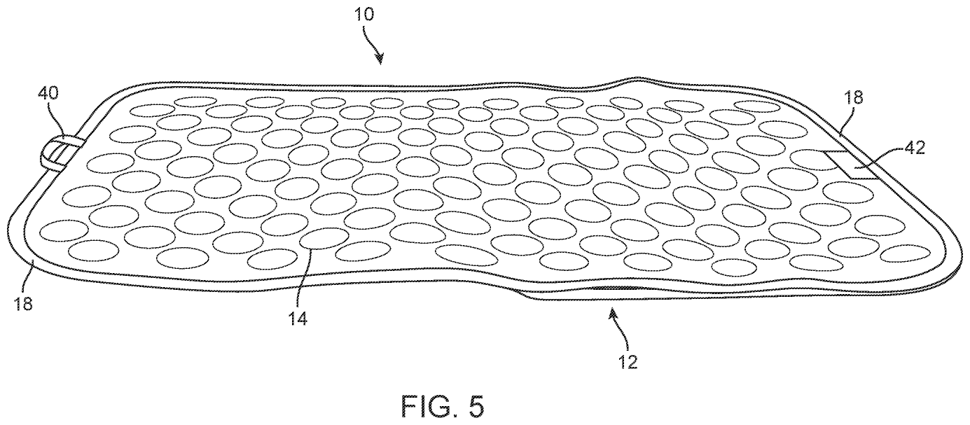

A sequence of unfolding and folding the mat of the preferred embodiment will now be described. As shown in FIG. 1, the closure flap 46 is moved away from the surface 20 of the extending layer 12 such that the cooperative hook and loop fastener portions 48 and 50 become disengaged. A user of the mat then grasps the loop 40 between a forefinger and thumb and pulls upward, which will result in the mat configuration shown in FIG. 2. Pulling farther upward will result in the mat configuration shown in FIG. 3. When the bottom of the mat as shown in FIG. 3 clears any supporting surface, the user may utilize the loop 40 and drop the mat onto a supporting surface (not shown) as depicted in FIG. 4. Dropping the mat farther will cause the mat to assume the condition shown in FIG. 5, laying on the support surface, with the B portion of the second surface of the base layer 10 and the second surface of the extending layer 12 resting on the supporting surface (nor shown).

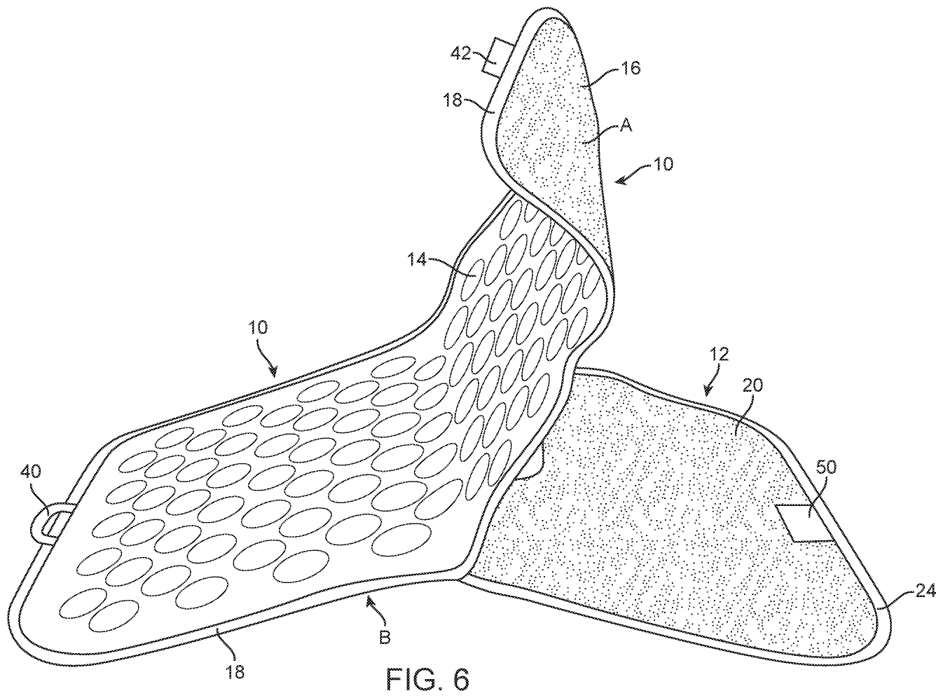

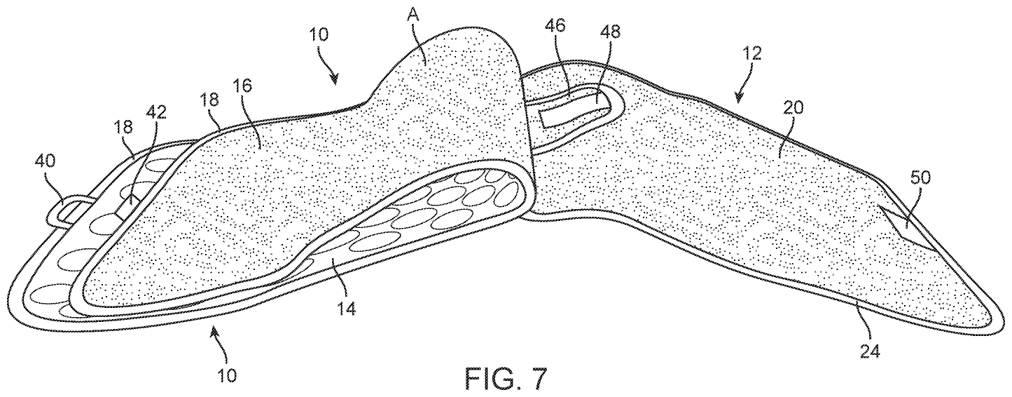

While the mat is in the condition shown in FIG. 5, a baby of other object may be placed on the mat, particularly the first surface 14 of the base layer 10, shown with a polka dot pattern. Debris and soiling such as baby powder may reside on the first surface 14 of the base layer 10, and may be cleaned with a damp cloth or sponge or alcohol wipe, if handy, or may be left. Also, items such as baby wipes may be left on the first surface 14 of the base layer 10. Next, the user grasps the tab 42, pulls upward, as shown in FIG. 6, and then folds the base layer 10 onto itself as shown in FIG. 7. It will be appreciated that this folding step causes any debris or soiling left on the first surface 14 of the base layer 10 to be sandwiched and trapped between the overlapping sections of the first surface 14 of the base layer 10.

As shown in FIGS. 7, 8, and 9, the user may then grasp the closure flap 46 and pull slightly upward and toward the extending flap 12 so that the A portion of the second surface 16 of the base layer 10 is exposed at the top and so that the first surface 20 of the extending layer 12 rests on the supporting surface (not shown).

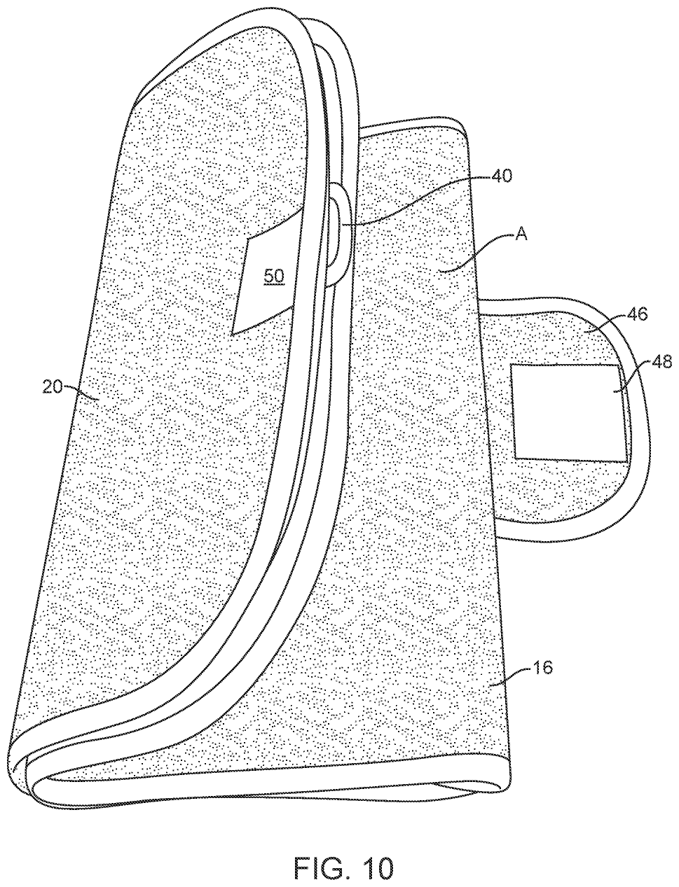

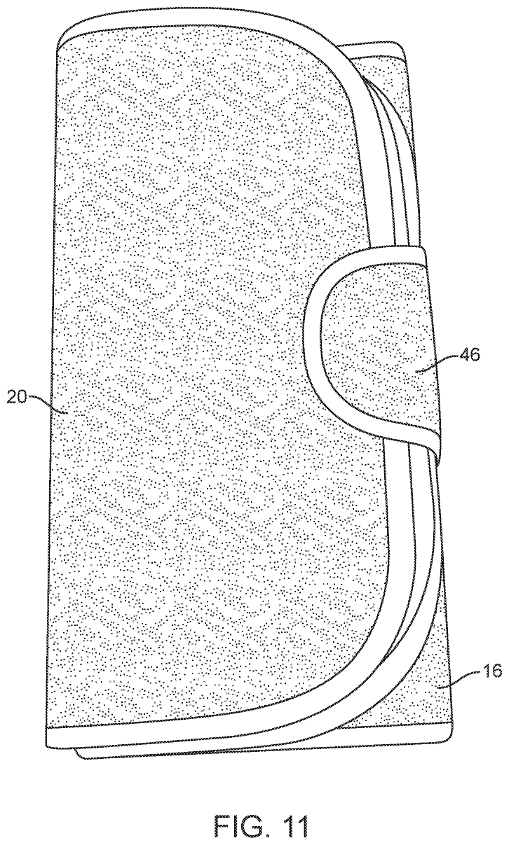

The user then grasps the left side of the folded mat as shown in FIG. 9 and folds the mat in half as shown in FIG. 10 whereby the second portion 50 of the cooperative hook and loop fastener member is disposed above and adjacent to the line of joinder between the extending layer 12 and the base layer 10 and is near the closure flap 46 bearing the first portion of the cooperative hook and loop fastener member. Finally the user moves the closure flap 46 such that both portions of the hook and loop fastener member are placed in intimate contact and selectively maintain the mat in the condition shown in FIG. 11.

It will be further appreciated that when the mat is folded in accordance with the aforementioned steps, the parts of the mat in contact with the supporting surface are also positioned in intimate, overlapping, facing contact so as to capture any debris or soiling that might have been residually retained on those surfaces. It will be further appreciated that the peripheral surfaces of the mat when folded in the condition shown in FIG. 11, are surfaces that did not contact the baby or other object and did not contact the supporting surface.

The mat as shown in FIG. 11 may be carried by hand, placed in a baby bag, a tote bag, a stroller, a car, etc. without concern for contact with debris or soiling or the spreading of contaminants and germs. The mat may be unfolded to wash with an outdoor spray hose, at a sink, or in an automatic washing machine. After washing, the mat may be refolded.

While various embodiments of the present invention have been described herein, it will be appreciated that the invention includes embodiments other than those specifically illustrated or described and that changes in the form and arrangement of parts and the specific manner of practicing the invention may be varied without departing from the nature or scope of the invention. Consequently the invention may be practiced otherwise than is specifically described above.

I claim:

1. A foldable mat comprising:
a base layer having opposing first and second surfaces, each surface having a substantially identical first peripheral configuration, said base layer having opposing first and second longitudinal ends; and
an extending layer having opposing first and second surfaces, each surface having a substantially identical second peripheral configuration, said extending layer having opposing first and second longitudinal ends, with a first longitudinal end of said extending layer joined to said base layer substantially midway between the longitudinal ends of said base layer.

2. A foldable mat according to claim 1 wherein the first peripheral configuration and the second peripheral configuration are each substantially rectangular.

3. A foldable mat according to claim 2 wherein the distance between the opposing longitudinal ends of said base layer is substantially twice the distance between the longitudinal ends of said extending layer.

4. A foldable mat according to claim 3 wherein the first surface of said base layer is fashioned of a substantially waterproof first material.

5. A foldable mat according to claim 3 wherein (a) the second surface of said base layer is fashioned of a second material on a first side of where the one longitudinal end of the extending layer joins to the second surface of said base layer, (b) the second surface of said base layer is fashioned of a third material on a second side of where the one longitudinal end of the extending layer joins to said base layer, (c) the first surface of said extending layer is fashioned of said second material, (d) the second surface of said extending layer is fashioned of said third material, and wherein the mat is adapted to be folded such that (1) the first surface of said extending layer may intimately face, overlap, and be substantially coextensive with the second material in second surface of said base layer, and (2) the second surface of said extending layer may intimately face, overlap, and be substantially coextensive with the third material in the second surface of said base layer.

6. A foldable mat according to claim 5 wherein the first, second, and third materials are flexible and deformable and wherein said base layer and the extending layer are flexible and deformable.

7. A foldable mat according to claim 6 further comprising means for selectively maintaining said base layer and said extending layer in a wrapped condition whereby (a) the first surface of said extending layer is intimate facing, overlapping and substantially coextensive with the second material in the second surface of said base layer, with the second longitudinal end of said extending layer substantially coextensive with the second longitudinal end of said base layer, (b) said base layer is folded such that said base layer overlaps on itself with the first longitudinal end of said base layer overlapping and substantially coextensive with the second longitudinal end of said base layer, and (c) said base layer and said extending layer are both folded such that the second longitudinal end of said extending layer, the second longitudinal end of said base layer, and the first longitudinal end of said base layer overlap and are substantially coextensive and all overlap the region where said extended layer joins said base layer.

8. A foldable mat according to claim 7 wherein said selective maintaining means comprises a cooperative hook and loop fastener.

9. A foldable mat according to claim 7 wherein said selective maintaining means is selected from the group consisting of a cooperative hook and loop fastener, a cooperative snap fit connector, a cooperative button and a buttonhole connector, a zipper, a clasp, and an elastic band.

10. A foldable mat according to claim 1 further comprising a fingerhold extending substantially centrally from the second longitudinal end of said base layer.

11. A foldable mat according to claim 10 further comprising a tab extending substantially centrally from the first longitudinal end of said base layer, said tab adapted to be grasped for manipulation of the positioning of said base layer and said extending layer.

12. A foldable mat according to claim 6 wherein the first longitudinal end of said extending layer is joined to said base layer by stitching.

13. A foldable mat according to claim 1 wherein the first longitudinal end of said extending layer is joined to said base layer by a means selected from the group consisting of stitching, a cooperative hook and loop fastening member, a cooperative a snap fit connector, and a zipper.

14. A foldable mat according to claim 6 wherein the first, second, and third materials are each different from the other materials.

15. A foldable mat according to claim 5 wherein the first, second and third materials each have a coloration different from the other materials.

16. A foldable mat according to claim 14 wherein the first material is substantially waterproof.

17. A foldable mat consisting essentially of:
a base layer having opposing first and second surfaces, each surface having a substantially identical first peripheral configuration, said base layer having opposing first and second longitudinal ends; and
an extending layer having opposing first and second surfaces, each surface having a substantially identical second peripheral configuration, said extending layer having opposing first and second longitudinal ends, with a first longitudinal end of said extending layer joined to said base layer substantially midway between the longitudinal ends of said base layer.

18. A foldable mat according to claim 17 wherein the first peripheral configuration and the second peripheral configuration are each substantially rectangular, wherein the first peripheral configuration and the second peripheral configuration are each substantially rectangular, and wherein the first surface of said base layer is fashioned of a substantially waterproof first material.

19. A foldable mat according to claim 17 wherein said base layer and said extending layer are flexible and deformable.

20. A method of using a foldable mat for changing the diaper of a baby comprising:
(a) providing a foldable mat comprising:
a base layer having opposing first and second surfaces, each surface having a substantially identical first peripheral configuration, said base layer having opposing first and second longitudinal ends;
an extending layer having opposing first and second surfaces, each surface having a substantially identical second peripheral configuration, said extending layer having opposing first and second longitudinal ends, with a first longitudinal end of said extending layer joined to said base layer substantially midway between the longitudinal ends of said base layer; and
wherein the first peripheral configuration and the second peripheral configuration are each substantially rectangular, wherein the first peripheral configuration and the second peripheral configuration are each substantially rectangular, wherein the first surface of said base layer is fashioned of a substantially waterproof first material, and wherein said base layer and the extending layer are flexible and deformable;
(b) utilizing a substantially horizontal supporting surface;
(c) laying the foldable mat on the supporting surface such that the second surface of said base layer and the first surface of said extending layer rest on the supporting surface, such that the second surface of said base layer is intimately facing the second surface of said extending layer and such that the second surface of said base layer and the second surface of said extending layer are out of contact with the supporting surface, and such that the first surface of said base layer is facing upwardly from above the supporting surface;
(d) placing a baby weaning diapers on the first surface of said base layer;
(e) changing the diapers of the baby;
(f) removing the baby from the first surface of said base layer;
(g) lifting and arranging the mat such that the second surface of said base layer intimately faces the first surface of said extending layer and such that the second surface of said base layer no longer intimately faces the second surface of said extending layer; and
(h) folding the mat such that substantially only the second surface of said base layer no longer intimately facing the second surface of said extending layer forms the outer periphery of the folded mat.

21. A method of using a foldable mat according to claim 20 wherein the mat further includes a means for selectively maintaining a folded condition and the method further comprises using said selective maintaining means to selectively maintain the mat in the folded condition accomplished by step (h).
